(19) United States
(12) Patent Application Publication
(10) Pub. No.: US 2008/0277398 A1
(43) Pub. Date: Nov. 13, 2008

(54) SEAM-WELDED 36% NI-FE ALLOY STRUCTURES AND METHODS OF MAKING AND USING SAME

(75) Inventor: Stuart L. Wilson, Pearland, TX (US)

Correspondence Address: CONOCOPHILLIPS COMPANY - IP Services Group;Attention: DOCKETING, 600 N. Dairy Ashford, Bldg. MA-1135, Houston, TX, 77079, US

(73) Assignee: ConocoPhillips Company, Houston, TX (US)

(21) Appl. No.: 11/746,307

(22) Filed: May 9, 2007

(51) Int. Cl. F17C 1/00; H01F 1/03

(52) U.S. Cl. 220/560.04; 148/120; 148/122; 148/327; 148/516; 148/579; 219/137 R; 29/773

(57) ABSTRACT

Welded 36% Ni—Fe alloy steel and a method of making such welded steel for use in storage tanks, pipelines, and other equipment associated with cryogenic substances is disclosed. The welded steel has a similar coefficient of thermal expansion in both the weld and base steel.

### CROSS-REFERENCE TO RELATED APPLICATIONS

Not applicable.

### STATEMENT REGARDING FEDERALLY SPONSORED RESEARCH

Not applicable.

### FIELD OF THE INVENTION

The present invention relates to welded steel and methods of making such welded steel for use in storage tanks, pipelines, and other equipment. More particularly, the welded steel, including the weld itself, is formed of an iron-nickel alloy having a low thermal expansion coefficient. Such welded steel may be used to form structures suitable for transport and/or storage of cryogenic substances, such as liquefied natural gas (LNG).

### BACKGROUND OF THE INVENTION

In various industries such as oil and gas, there is a need to store and transport substances at cryogenic conditions, wherein a substance may be cooled and liquefied from a gaseous state. For example, there is a need for containers for storing and transporting LNG at cryogenic conditions such as temperatures ranging from about −110° C. to about −170° C. and at pressures in the broad range of about atmospheric to about 6000 kPa. There is also a need for containers for safely and economically storing and transporting other pressurized fluids, such as oxygen, nitrogen, helium, hydrogen, argon, neon, fluorine, air, methane, ethane, or propane, at cryogenic temperatures.

Several challenges exist when selecting materials to store or transport cryogenic substances. The materials selected must maintain sufficient ductility and tensile strength to avoid failure under cryogenic conditions. Ductile materials are favored because they deform under excessive stress, while brittle materials fracture. Many materials transition from ductile to brittle behavior as the temperature is lowered, making them inadequate for cryogenic applications. Meanwhile, the material must also have a low coefficient of thermal expansion (CTE). The CTE quantifies the amount of contraction within a material as the temperature is lowered. These contractions create thermal stress within a cryogenic structure and modify its geometry; therefore a lower CTE minimizes these effects. In particular, cryogenic pipes often require pipe looping to alleviate thermal stresses caused by a high CTE at the sacrifice of impeding flow within the pipe.

Generally, metals are favored for cryogenic structures because of their high mechanical strength and ductile behavior at low temperatures. Although many metals are brittle at cryogenic conditions, metals having a face-centered cubic crystalline structure (fcc), such as aluminum, copper, nickel and their alloys, are ductile. Nickel-iron alloys comprising between 35-50% by weight nickel are favored fcc metals because of their low CTE. 36% Ni—Fe alloy, sometimes referred to as FeNi36 and commonly sold under the trademark “Invar” by Imphy Alloys, is preferred because it has an exceptionally low CTE.

The processing of metals into cryogenic structures also creates unique difficulties. It is desirable to produce structures having uniform material properties throughout. In particular, it is desirable for cryogenic structures to exhibit uniform mechanical strength and thermal expansion properties. If a structure is not of uniform mechanical strength, fracture will likely initiate at the mechanically weaker regions at stresses tolerated by the stronger regions. Meanwhile, inhomogeneous thermal expansion behavior creates additional stresses under cryogenic conditions. When one region of a structure exhibits greater contraction because of a higher CTE, additional stress is created along the boundary between the high and low CTE regions that may cause mechanical failure. This phenomenon is often referred to as “CTE mismatch.”

To avoid variances in mechanical strength and CTE, metallic cryogenic structures are often formed from a single mold or billet to obtain homogenous material properties. For example, a metal pipe can be formed from a single billet of steel by first heating the billet to around 1000° C. and piercing a longitudinal hole through the axis of the billet using the Mannesmann piercing method. The wall-thickness and diameter are then formed into the desired geometry by a series of extrusion and hot or cold sizing methods. Such processes are effective in obtaining homogenous mechanical strength and CTE for cryogenic structures; however their utility is limited because of economic and size considerations. Generally, forming a billet or mold is more expensive than other techniques because of the high temperatures and extensive extrusion and sizing required. Also, the overall size of the formed structure is limited by the volume of the mold or billet to be processed. It is impracticable to form metallic cryogenic structures from a single mold or billet beyond a certain size because of the limited volumes that can currently be produced via casting, forging or any other method. Transportation constraints may also limit the size of structures formed from a single mold or billet.

As an alternative to forming metallic cryogenic structures from a single mold or billet, a structure may be fabricated using a welding process, where material is joined along a seam. A typical welding process involves the application of some energy source along the seam to form a pool of molten material that coalesces and forms a solid joint upon cooling. There are numerous energy sources that may be used for welding cryogenic structures, including gas flame, electric arc, laser, electron beam, friction and ultrasound.

Often a filler material is added along the seam to aid the welding of the base material. The filler material is melted during the welding process and coalesces to become part of the weld bead that solidifies along the seam of the joint. Filler material is often used to improve various properties of the weld. For example, a filler material may be selected so that the weld is mechanically stronger than the base material to ensure mechanical failure does not occur along the welded seam.

An example of the utilization of welding techniques for cryogenic structures is the production of pipes. A pipe may be produced by first forming a metallic plate into a tubular shape of specified diameter, length, and longitudinal seam region using a high-speed roll forming mill. The seam region may then be welded using gas tungsten arc welding, also known as tungsten inert gas (TIG) welding, with a metallic filler material that is mechanically stronger than the base material, as required by piping and cryogenic industry standards.

Welding techniques are often preferred for producing cryogenic structures because they enable the production of larger structures and are more economical than forming a billet or mold. Instead of forming a billet or mold, the source material can be a metal plate formed by lower-cost continuous casting. The welding process allows multiple plates to be joined if necessary. Accordingly, the size of the fabricated structure is not limited by the source material, and in some instances may be fabricated onsite to avoid transportation limitations. Furthermore, the welding process itself may be more economical than the alternative of extrusion and/or hot and cold working.

Notwithstanding the benefits, the utilization of welding techniques for the fabrication of cryogenic structures is limited because they inherently create inhomogeneous material properties. The welded seam usually has different mechanical properties because the welding process creates a different microstructure along the seam. Typically, welding with a filler material that matches the base metal creates larger grain sizes along the seam, which results in a mechanically weaker seam that is susceptible to failure. To avoid failure along the welded seam, a mechanically stronger filler material is often used to make the seam stronger than the base material. Nevertheless, the stronger filler material used to weld 36% Ni—FE alloys usually has a larger CTE than the base material (because of the alloy additions for strength), which results in a CTE mismatch that may fail under cryogenic conditions. Thus, an ongoing need exists for improved seam-welded 36% Ni—Fe alloy structures and methods of making and using same.

### SUMMARY OF THE INVENTION

The present invention relates to a process for welding a structure having a similar coefficient of thermal expansion in both the weld and base material of the structure. More particularly, the present invention relates to novel methods of producing structures from 36% Ni—Fe alloy, for example structures such as pipe for use in cryogenic applications such as transport, conveyance, or storage of a cryogenic liquid.

In an embodiment, a method of welding a structure includes: (1) forming a structure of desired wall thickness, length, and seam region, (2) welding the structure along the seam region with 36% Ni—Fe alloy such that excess weld alloy is left as part of a weld bead at the seam region, (3) work hardening (e.g., cold working) the weld bead such that the thickness at the seam region is approximately the same as the desired wall thickness of the structure, and (4) heat treating the seam region. Upon completion of heat treating, the grain size within the seam region is similar to that of the rest of the structure. Such structures are useful in cryogenic applications and conditions.

In another embodiment, a pipe includes: (1) a tubular body having a predetermined wall thickness and length, and (2) a welded seam extending the length of the tubular body. The tubular body and welded seam are fabricated from 36% Ni—Fe alloy and have substantially the same grain size. Such pipes are useful in cryogenic applications and conditions.

These and other embodiments, features and advantages of the present invention will become apparent with reference to the following detailed description and examples.

### BRIEF DESCRIPTION OF THE DRAWINGS

For a more detailed description of the present invention, reference will now be made to the accompanying Figures, wherein:

FIG. 1 is graph of the coefficients of thermal expansion of various Ni—Fe alloy compositions;

FIG. 2 is a flow diagram of processing steps in accordance with the present invention; and

FIGS. 3a-3b are perspective views of different weld joints in accordance with the present invention.

### DETAILED DESCRIPTION OF PREFERRED EMBODIMENTS

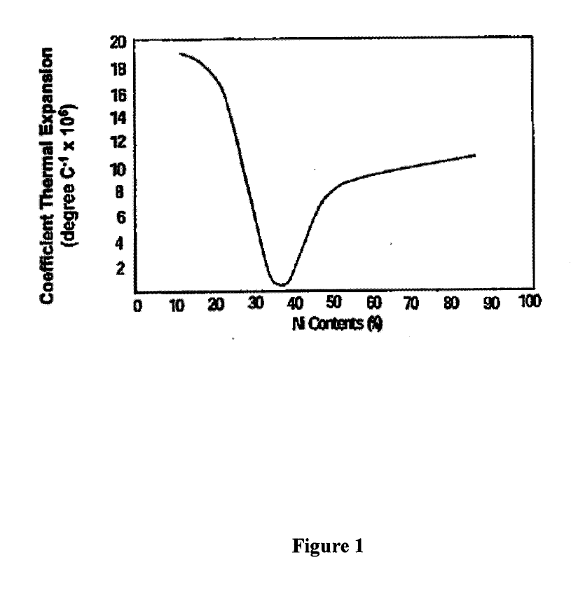

The present invention relates to the welding of 36% Ni—Fe alloy, which may be formed into structures (e.g., pipe) suitable for use under cryogenic conditions. 36% Ni—Fe alloy is desirable for use in cryogenic structures because it is ductile at cryogenic temperatures and the composition produces a minimum in CTE for Ni—Fe alloys that is exceptionally low. Referring to FIG. 1, a graph illustrating the CTE over a range Ni—Fe alloy compositions is shown. From FIG. 1 it is clear that there is a distinct CTE minimum of about 1.3×10⁻⁶ ° C.⁻¹ at −196° C. for 36% Ni—Fe alloy. This is approximately 1/10 the CTE of typical stainless steel.

As used herein, 36% Ni—Fe alloy is defined by ASTM F 1684 or ASTM A 333/A 333M specifications, each of which is incorporated by reference herein in its entirety. In embodiments, the 36% Ni—Fe alloy comprises 36% Ni with the balance Fe and trace elements in amounts described in the ASTM specifications. In an embodiment, the 36% Ni—Fe alloy comprises alloy UNS No. K93603 as described in ASTM F 1684. In an embodiment, the 36% Ni—Fe alloy comprises alloy Grade 11 as described in ASTM A 333/A 333M. In an embodiment, the 36% Ni—Fe alloy comprises one or more alloys described in Table 1. In an embodiment, the 36% Ni—Fe alloy comprises an alloy having a minimum CTE as shown in the plot of FIG. 1. All elements are understood to be given by weight %.

TABLE 1
ASTM F1684

| | UNS No. K93603 | UNS No. K93050 |
|---|---|---|
| Element | Composition, % | Composition, % |
| Iron, nominal | remainder^{A} | remainder^{A} |
| Nickel, nominal | 36^{A} | 36^{A} |
| Cobalt, max | 0.50 | 0.50 |
| Manganese, max | 0.60 | 1.00 |
| Silicon, max | 0.40 | 0.35 |
| Carbon, max | 0.05 | 0.15 |
| Aluminum, max | 0.10^{B} | . . .^{C} |
| Magnesium, max | 0.10^{B} | . . .^{C} |
| Zirconium, max | 0.10^{B} | . . .^{C} |
| Titanium, max | 0.10^{B} | . . .^{C} |
| Chromium, max | 0.25 | 0.25 |
| Selenium | . . . | 0.15 to 0.30 |
| Phosphorus, max | 0.015^{D} | 0.020 |
| Sulfur, max | 0.015^{D} | 0.020 |

^{A}For UNS No. K93603 and K93050, the iron, and nickel requirements are nominal. These levels may be adjusted by the manufacturer to meet the requirements for the coefficient of thermal expansion as specified in 12.1.
^{B}The total of aluminum, magnesium, titanium, and zirconium shall not exceed 0.20%
^{C}These elements are not measured for this alloy.
^{D}The total of phosphorous and sulfur shall not exceed 0.025%.

TABLE 2
ASTM A333/A333M

| Element | Composition, % - Grade 11 |
|---|---|
| Carbon, max | 0.10 |
| Manganese | 0.60 max |
| Phosphorus, max | 0.025 |
| Sulfur, max | 0.025 |
| Silicon | 0.35 max |
| Nickel | 35.0–37.0 |
| Chromium | 0.50 max |
| Copper | . . . |
| Aluminum | . . . |
| Vanadium, max | . . . |
| Columbium, max | . . . |
| Molybdenum, max | 0.50 max |
| Cobalt | 0.50 max |

The starting or base material is preferably one or more plates produced by continuous casting or a similar method known in the art. In embodiments, the plates are further characterized as set forth in the ASTM F 1684 or ASTM A 333/A 333M specifications. The metal plates may be subjected to further processing to achieve desired properties, such as smoothness, corrosion resistance, etc. The plates preferably have a substantially homogenous microstructure so as to ensure uniform mechanical properties within the starting material.

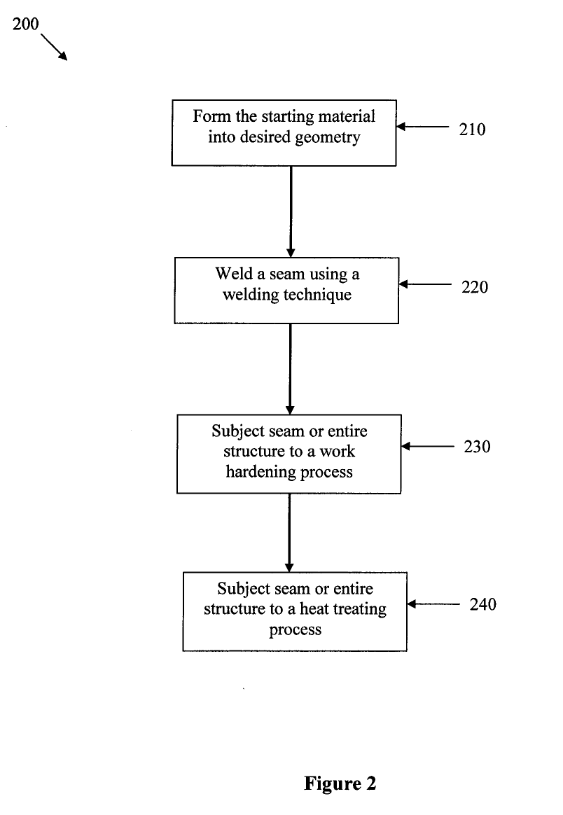

Referring now to FIG. 2, a flow diagram is shown illustrating the processing steps 200 in accordance with the present disclosure. As mentioned above, the starting material may be initially subjected to various metalworking processes known within the art to form the plate into a desired geometry 210 before welding. The starting material may be machined by various techniques, including drilling, turning, threading, cutting, grinding or any other method known in the art. Furthermore, the starting material may be formed via forging, rolling, rolling, extrusion, spinning, bending, or any other technique known in the art. For example, the plate may subjected to hot or cold rolling to form a tubular shape to produce a pipe. In some embodiments, the pipe edges may then be tapered using machining techniques.

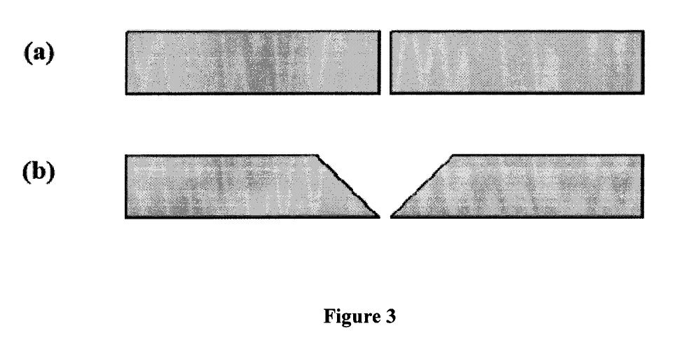

Once the desired geometry is achieved, at least one seam is welded using a welding technique 220 such as shielded metal arc, gas tungsten arc or tungsten inert gas (TIG), gas metal arc or metal inert gas (MIG), plasma arc, electron beam, oxyacetylene, spot welding, seam welding, projection welding, flash welding or any other technique known in the art. Any joint type may be utilized for welding. For example, a butt joint as shown in FIG. 3a or a single-V preparation joint as shown in FIG. 3b may be used. Additional suitable joint types include corner joints, edge joints, double-V preparation joints, single-U joints, and double-U joints. For example, as shown in FIG. 3b, single-V preparation joint includes two tapered surfaces that meet at a single point along the axis of the seam to form a V-shape. The void within the joint geometry accommodates a filler material that is added during the welding process to form a weld bead, which is intentionally made thicker than the base material to accommodate future cold reduction. A filler material may be used that is exactly or substantially the same composition as the 36% Ni—Fe alloy base material to fill voids formed in various joint types. Matching the filler and base materials ensures the CTE is exactly or substantially the same in both the welded seam and the base material and avoids a CTE mismatch. In an embodiment, the filler material of 36% Ni—Fe alloy is used to form a weld bead via gas tungsten arc welding within a single-V joint formed from 36% Ni—Fe plate(s).

After the welded seam has solidified, the seam is subjected to a work hardening process 230, such as cold rolling, planishing, or any other method known within the art, so as to cold work the welded seam. Without intending to be limited by theory, it is believed that the work hardening process 230 increases the density of dislocations and/or adds activation energy to the material for use in grain refining during the subsequent heat treating or annealing process. The yielding mechanism of metals involves the movement of dislocations. Increasing the density of dislocations impedes movement because the dislocations are likely to cross each other, forming a “jog.” Because the mechanism for yielding is impeded, the yield strength in the welded seam is increased. In an embodiment, the welded seam is work hardened by planishing the seam to reduce the thickness of the seam. The planished seam may be reduced in thickness by from about 20% to about 60%, alternatively by about 20, 25, 30, 35, 40, 45, 50, 55, or 60%. In an embodiment, the seam is planished such that the weld bead is of similar thickness to (e.g., about or substantially equal to) the base material.

The welded seam or the entire structure is subjected to a heating treating or annealing process 240, so as to reduce the grain size within the welded seam to a similar grain size of (e.g., about or substantially equal to) the base material. In an embodiment, the average grain size within the welded seam deviates from the average grain size in the base material by 10% or less. Without intending to be limited by theory, it is believed that the reduction of grain size results in more grain boundaries that pin the motion of dislocations that enable yielding, the yield strength is increased. And, because the amount of stress required to fracture a material is inversely proportional to grain size, the ultimate tensile strength of the material is increased by the heat treating process. Upon completion of the heat treating process 240, the weld bead may equal or exceed the strength of the base material. For example, the weld bead and the base material may both exceed the minimum tensile strength set forth in applicable specifications such as ASTM specifications disclosed herein.

In an embodiment, the welded seam itself is subjected to localized heating or the entire structure is heated under conditions effective to refine the grain size, to achieve a uniform grain structure that permits ductile behavior, to recrystallize the welded seam or seam region, or combinations thereof. Suitable heat treating conditions include heating the welded seam and/or entire structure at times and temperatures sufficient or effective to cause the welded seam and/or seam region to undergo such changes (e.g., recrystallization, grain size refinement/uniformity, etc.). In an embodiment, the welded seam and/or the entire structure is heated to 760 to 870° C. (1400 to 1600° F.) for a time sufficient or effective to undergo such changes (e.g., recrystallization, grain size refinement/uniformity, etc.). The welded seam or entire structure may be subjected to multiple heat treating cycles.

Upon heat treating, the seam or entire structure may be subjected to various intermediate and/or finishing techniques including blasting, cleaning, and pickling as desired. For example, in some instances it may be desirable to ultrasonically inspect the weld. Likewise, in some instances, the structure may be subjected to blasting or chemical pickling to remove oxide deposits. Coatings may optionally be applied to the manufactured structure.

Since the completed welded seam is of a similar composition and grain structure of the base material, the process creates a structure of approximately uniform mechanical strength and thermal expansion properties utilizing standard welding techniques. The mechanical strength of the structure should be sufficient to operate under cryogenic conditions, as measured by the yield strength, ultimate tensile strength and toughness.

The ultimate tensile strength may be measured by standard tensile testing techniques, such as those set forth in ASTM Standard E8-04, “Standard Testing Methods for Tension Testing of Metallic Materials,” incorporated by reference herein in its entirety. In an embodiment, both the base material and welded seam of the structure have an ultimate tensile strength of equal to or greater than 58 ksi at room temperature, alternatively equal to or greater than 60 ksi, or alternatively equal to or greater than 65 ksi.

The yield strength may be measured by standard tensile testing techniques, such as those set forth in ASTM Standard E8-04, “Standard Testing Methods for Tension Testing of Metallic Materials.” In a preferred embodiment, both the base material and welded seam of the structure have a yield strength of equal to or greater than 30 ksi at room temperature, alternatively equal to or greater than 33.33 ksi, or alternatively equal to or greater than 35 ksi.

The present invention may be used to fabricate any structure for use in an industrial process, for example structures requiring low CTE such as those operating under cryogenic conditions. In particular, the invention is suited for fabricating structures for the storage, conveyance, and transportation of liquefied gases, including but not limited to, nitrogen, oxygen, helium, hydrogen, neon, fluorine, argon, methane, air, propane (LP), and natural gas (LNG). In an embodiment, structures as described herein may be used in a LNG process. Examples of suitable gas liquefaction process and associated equipment and structures are disclosed in U.S. Pat. App. Pub. No. 20030005698 and U.S. Pat. Nos. 7,074,322; 7,047,764; 7,127,914; 6,722,157; 6,658,8921 6,647,744; 6,250,105; 6,158,240; 6,125,653; 6,070,429; 6,023,942; 5,724,833; 5,651,270; 5,600,969; 5,611,216; 5,473,900; 4,698,080; 4,548,629; 4,430,103; 4,225,329; 4,195,979; and 4,172,7111, each of which is incorporated herein by reference in its entirety.

Structures that may be implemented using the present invention include geometries commonly used in piping, such as tubular shapes or elbow joints, or those in storage tanks, such as a sphere or cylinder with dished, elliptical or flat ends. Such pipes and storage tanks may be used in on-shore or off-shore liquefaction, transport, storage, or regasification facilities, including marine facilities such as platforms, docks, and tanker ships. In any of the structures chosen, it is understood that the structure includes a desired wall thickness, length, and seam region. The present invention is especially suited for the production of pipes, where a tubular shape is easily formed from a plate and contains a linear seam that can be readily planished.

While preferred embodiments of this invention have been shown and described, modification thereof can be made by one skilled in the art without departing from the spirit or teaching of this invention. The embodiments described herein are exemplary only and are not limiting. Many variations and modifications of the system and apparatus are possible and are within the scope of this invention. For example, the present invention is not intended to be limited to any particular geometry and may be used to fabricate any structure that operates under cryogenic conditions. Accordingly, the scope of protection is not limited to the embodiments described herein, but is only limited by the claims, which follow, the scope of which shall include all equivalents of the subject matter of the claims. In particular, unless order is explicitly recited, the recitation of steps in a claim is not intended to require that the steps be performed in any particular order, or that any step must be completed before the beginning of another step.

What is claimed is:

1. A method of welding a structure comprising:
forming a structure of desired wall thickness, length, and seam region, wherein the structure is fabricated from 36% Ni—Fe alloy base material;
welding the structure along the seam region with 36% Ni—Fe alloy filler such that excess weld reinforcement is left as part of a weld bead at the seam region;
cold working the weld bead such that the thickness at the seam region is reduced; and
heat treating the seam region under conditions effective to cause the seam region to have an ultimate tensile strength, yield strength, or both about equal to or greater than the base material.

2. The method of claim 1 wherein the seam region and base material have an ultimate tensile strength of equal to or greater than 58 ksi.

3. The method of claim 1 wherein the seam region and base material have a yield strength of equal to or greater than 30 ksi.

4. The method of claim 1 wherein coefficient of thermal expansion is about equal in the base material and the seam region.

5. The method of claim 1 wherein grain size is about equal in the base material and the seam region.

6. The method of claim 1 wherein the heat treating is performed at temperatures in a range of from about 1400 to about 1600° F. for a time effective to recrystallize the seam region.

7. The method of claim 1 wherein the thickness at the seam region is reduced in a range of from about 20% to about 80% following cold working.

8. The method of claim 1 wherein the thickness at the seam region is substantially the same as the desired wall thickness of the structure following cold working.

9. The method of claim 1 wherein the welding is performed using tungsten inert gas welding.

10. The method of claim 1 wherein the seam region is formed from a single-V preparation joint.

11. The method of claim 1 wherein the forming a structure further comprises shaping a plate to form the seam region.

12. The method of claim 11 wherein the structure is a pipe or storage tank rated for cryogenic service.

13. A method of welding a structure comprising:
forming a structure of desired wall thickness, length, and seam region, wherein the structure is fabricated from 36% Ni—Fe alloy base material;
welding the structure along the seam region with 36% Ni—Fe alloy filler material such that excess weld reinforcement is left as part of a weld bead at the seam region;
cold working the weld bead such that the thickness at the seam region is reduced; and
heat treating the seam region under conditions effective to cause the seam region to recrystallize.

14. The method of claim 13 wherein upon recrystallization, the seam region and the base material have an about equal grain size.

15. A structure having at least one welded seam region, wherein the structure and the welded seam region are fabricated from 36% Ni—Fe and wherein the structure and the welded seam region have an about equal coefficient of thermal expansion.

16. The structure of claim 15 wherein the structure and the welded seam region have an ultimate tensile strength of equal to or greater than 58 ksi, a yield strength of equal to or greater than 30 ksi, or both.

17. The structure of claim 15 wherein the structure comprises a pipe or a storage tank rated for service at cryogenic conditions.

18. A structure having at least one welded seam region, wherein the structure and the welded seam region are fabricated from 36% Ni—Fe alloy and have an about equal grain size.

19. The structure of claim 18 wherein the structure and the welded seam region have an about equal coefficient of thermal expansion.

20. A structure having at least one welded seam region, wherein the structure and the welded seam region are fabricated from 36% Ni—Fe alloy and have an ultimate tensile strength of equal to or greater than 58 ksi, a yield strength of equal to or greater than 30 ksi, or both.
